(19) United States
(12) Patent Application Publication
(10) Pub. No.: US 2021/0235551 A1
(43) Pub. Date: Jul. 29, 2021

(54) HEATER DEVICE

(71) Applicant: DENSO CORPORATION, Kariya-city (JP)

(72) Inventors: Masashi WATANABE, Kariya-city (JP); Kotaro FUKUDA, Kariya-city (JP); Takumi OKAMOTO, Kariya-city (JP); Taro OGURA, Kariya-city (JP)

(21) Appl. No.: 17/229,327

(22) Filed: Apr. 13, 2021

Related U.S. Application Data
(63) Continuation of application No. PCT/JP2019/040930, filed on Oct. 17, 2019.

(30) Foreign Application Priority Data
Oct. 25, 2018 (JP) 2018-200942
Jan. 11, 2019 (JP) 2019-003823
Aug. 9, 2019 (JP) 2019-147841

(51) Int. Cl. H05B 3/84; H04N 5/225; H05B 3/20; H05B 3/03

(52) U.S. Cl. CPC H05B 3/84; H04N 5/22521; H05B 2203/006; H05B 3/03; H05B 3/20

(57) ABSTRACT

A heater device includes a light transmissive film heater configured to apply to an optical window that is arranged adjacent to a sensor unit for detecting light and includes a detection surface having a light transmitting property, and including a heating portion heating the optical window, and a heat generating portion configured to generate heat in a predetermined region. The light transmissive film heater includes a first electrode arranged radially outside about a center line of the detection surface in the heating portion, a second electrode arranged in the heating portion so as to interpose the detection surface from both sides together with the first electrode, and a first heat generation region that generates heat according to a potential difference between the first electrode and the second electrode generated by energization from the first electrode to the second electrode via the heating portion.

### CROSS REFERENCE TO RELATED APPLICATIONS

This application is a continuation application of International Patent Application No. PCT/JP2019/040930 filed on Oct. 17, 2019, which designated the U.S. and based on and claims the benefits of priorities of Japanese Patent Application No. 2018-200942 filed on Oct. 25, 2018, Japanese patent application No. 2019-3823 filed on Jan. 11, 2019, and Japanese patent application No. 2019-147841 filed on Aug. 9, 2019. The entire disclosure of all of the above applications is incorporated herein by reference.

### TECHNICAL FIELD

The present disclosure relates to a heater device.

### BACKGROUND

Conventionally, there is a device provided with a light transmitting sensor array arranged on a window glass of a vehicle and a flat superheatable film arranged on the light transmitting sensor array.

### SUMMARY

According to one aspect of the present disclosure, a heater device includes a light transmissive film heater configured to apply to an optical window that is arranged adjacent to a sensor unit for detecting light and includes a detection surface having a light transmitting property, and including a heating portion heating the optical window, and a heat generating portion configured to generate heat in a predetermined region. The light transmissive film heater includes a first electrode arranged radially outside about a center line of the detection surface in the heating portion, a second electrode arranged in the heating portion so as to interpose the detection surface from both sides together with the first electrode, and a first heat generation region that generates heat according to a potential difference between the first electrode and the second electrode generated by energization from the first electrode to the second electrode via the heating portion. The heat generating portion generates heat in the predetermined region so as to have a temperature distribution in which a temperature of an outer region located radially outside about a center line of the detection surface with respect to the heat generation region is higher than the temperature of the first heat generation region.

### BRIEF DESCRIPTION OF DRAWINGS

FIG. 1 is a diagram showing a configuration of an optical device according to a first embodiment;

FIG. 2 is a diagram showing a configuration of a light transmissive film heater of the optical device according to the first embodiment;

FIG. 3 is a diagram showing a configuration of a light transmissive film heater of the optical device according to a second embodiment;

FIG. 4 is a diagram showing a heat generating region of the optical device according to the second embodiment;

FIG. 5 is a diagram showing a configuration of a light transmissive film heater of the optical device according to a third embodiment;

FIG. 6 is a diagram showing a configuration of a light transmissive film heater of the optical device according to a fourth embodiment;

FIG. 7 is a diagram showing a configuration of a light transmissive film heater of the optical device according to a fifth embodiment;

FIG. 8 is a diagram showing a configuration of a light transmissive film heater of the optical device according to a sixth embodiment;

FIG. 9 is a diagram showing a configuration of a light transmissive film heater of the optical device according to a seventh embodiment;

FIG. 10 is a diagram showing a configuration of a light transmissive film heater of the optical device according to an eighth embodiment;

FIG. 11 is a diagram showing a configuration of a light transmissive film heater of the optical device according to a ninth embodiment; and

FIG. 12 is a diagram showing a configuration of a light transmissive film heater of the optical device according to a tenth embodiment.

### DETAILED DESCRIPTION

In an assumable example, there is a device provided with a light transmitting sensor array arranged on a window glass of a vehicle and a flat superheatable film arranged on the light transmitting sensor array. This device heats the light transmitting sensor array with a superheatable film to prevent dew condensation on the light transmitting sensor array.

According to a study, in a planar superheatable film, when the window glass is cooled, heat is taken from three directions, namely both plane surfaces and the side surface of the superheatable film. At this time, heat is uniformly taken from both plane surfaces of the superheatable film over the entire surface, but heat is taken from a peripheral edge of the superheatable film at the side surface of the superheatable film. Therefore, for example, when a calorific value decreases, fogging occurs from the peripheral edge of the superheatable film. An object of the present disclosure is to make it possible to further suppress the occurrence of fogging.

According to one aspect of the present disclosure, a heater device includes a light transmissive film heater configured to apply to an optical window that is arranged adjacent to a sensor unit for detecting light and includes a detection surface having a light transmitting property, and including a heating portion heating the optical window, and a heat generating portion configured to generate heat in a predetermined region. The light transmissive film heater includes a first electrode arranged radially outside about a center line of the detection surface in the heating portion, a second electrode arranged in the heating portion so as to interpose the detection surface from both sides together with the first electrode, and a first heat generation region that generates heat according to a potential difference between the first electrode and the second electrode generated by energization from the first electrode to the second electrode via the heating portion. The heat generating portion generates heat in the predetermined region so as to have a temperature distribution in which a temperature of an outer region located radially outside about a center line of the detection surface with respect to the heat generation region is higher than the temperature of the first heat generation region.

According to such a configuration, the heating portion has a first heat generation region that generates heat according to the potential difference between the first electrode and the second electrode, and the heat generation portion generates heat in the outer region located radially outside the center line of the predetermined region of the optical window with respect to the first heat generation region. Therefore, the occurrence of fogging from the peripheral edge of the heating portion can be suppressed, and the occurrence of fogging can be further suppressed.

Hereinafter, embodiments of the present disclosure will be described with reference to the drawings. In the following embodiments, identical or equivalent elements are denoted by the same reference numerals as each other in the figures.

### First Embodiment

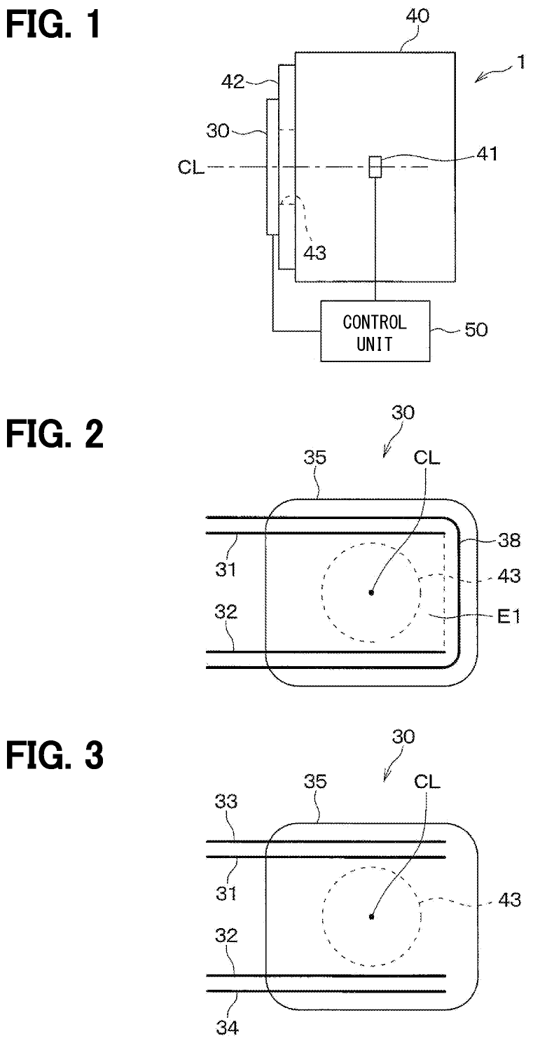

An optical device according to the first embodiment will be described with reference to FIGS. 1 and 2. As shown in FIG. 1, the optical device 1 includes a camera 40, a light transmissive film heater 30, and a control unit 50. The optical device 1 of the present embodiment captures an image with the camera 40.

The camera 40 includes an optical window 42 and a sensor unit 41. The planar optical window 42 is provided with a detection surface 43 having light transmitting property. A center line CL of the detection surface 43 is perpendicular to the planar optical window 42.

The sensor unit 41 senses a light that has passed through the detection surface 43. The sensor unit 41 is composed of an image sensor such as a CCD (Charged-Coupled Devices) or a CMOS (Complementary Metal-Oxide-Semiconductor). The camera 40 sends the image captured by the sensor unit 41 to the control unit 50.

The light transmissive film heater 30 has a first electrode 31, a second electrode 32, a heating portion 35, and a heat ray heater 38. The first electrode 31 and the second electrode 32 are made of a conductive metal. The first electrode 31 and the second electrode 32 each have a linear shape. The first electrode 31 and the second electrode 32 are formed on one surface of the heating portion 35 by printing or the like. The first electrode 31 and the second electrode 32 are arranged so as to avoid the detection surface 43. Specifically, the first electrode 31 and the second electrode 32 are arranged so as to interpose the detection surface 43 from a radial outside centering on the center line CL of the detection surface 43. The first electrode 31 and the second electrode 32 are connected to the control unit 50, respectively.

The heating portion 35 is arranged adjacent to an opposite surface with respect to a surface facing the sensor unit 41 of the optical window 42. That is, the heating portion 35 is arranged adjacent to the optical window 42 having the detection surface 43 and heats the optical window 42.

The heating portion 35 can be made of, for example, a transparent conductive film. By energizing the transparent conductive film through the first electrode 31 and the second electrode 32, the transparent conductive film generates heat. A thickness of the heating portion 35 is uniform. Further, the heating portion 35 is made homogeneous.

The heat ray heater 38 is arranged in an outer region on the radial outer side of the detection surface 43. The heat ray heater 38 is formed along a peripheral edge of the heating portion 35. The heat ray heater 38 has a linear shape. The heat ray heater 38 generates heat due to Joule heat generated when an electric current flows through the heat ray heater 38.

In the light transmissive film heater 30, the heat ray heater 38 is formed along the peripheral edge of the heating portion 35, and the light transmissive film heater 30 has a temperature distribution in which a temperature of the outer region on the radial outer side of the detection surface 43 in the heating portion 35 is higher than a temperature of the region on the center side of the detection surface 43 from the outer region in the heating portion 35.

Further, the optical device 1 of the present embodiment includes a sensor unit 41 that detects light that has passed through the detection surface 43 having the light transmitting property. Further, the optical device 1 includes the light transmissive film heater 30 which is arranged adjacent to the optical window 42 having the detection surface 43 and have the heating portion 35 heating the optical window 42, and the heat ray heater 38 as a heat generating portion so as to generate heat in the predetermined region.

Further, the light transmissive film heater 30 has a first electrode 31 arranged radially outside the center line of the detection surface 43 in the heating portion 35, and a second electrode 32 arranged so as to interpose the detection surface 43 from both sides together with the first electrode 31 in the heating portion 35. Further, the heating portion 35 has a first heat generating region E1 in which heat generates according to the potential difference between the first electrode 31 and the second electrode 32. Then, the heat ray heater 38 as the heat generating portion generates heat in the outer region located radially outside the center line CL of the detection surface 43 from the first heat generating region E1.

The control unit 50 is configured as a computer equipped with a CPU, a memory, an I/O, and the like, and the CPU executes various processes according to a program stored in the memory.

As a processing of the control unit 50, for example, when it is determined that a cloudy is occurred on the detection surface 43 based on the image input from the camera 40, a predetermined voltage is applied to the first electrode 31 and the second electrode 32 of the light transmissive film heater 30, and the energization of the heat ray heater 38 is started.

When the predetermined voltage is applied between the first electrode 31 and the second electrode 32 of the light transmissive film heater 30 by the control unit 50, the heating portion 35 generates heat. Further, when the control unit 50 starts energizing the heat ray heater 38, the heat ray heater 38 generates heat. The heat ray heater 38 heats the outer region on the outer side in the radial direction about the center line of the detection surface 43.

The heat ray heater 38 is formed along the peripheral edge of the heating portion 35, and the light transmissive film heater 30 has a temperature distribution in which a temperature of the outer region on the radial outer side of the detection surface 43 in the heating portion 35 is higher than a temperature of the region on the center side of the detection surface 43 from the outer region in the heating portion 35. As a result, the generation of fogging from the peripheral edge of the heating portion 35 is suppressed.

As described above, the optical device of the present embodiment includes a sensor unit 41 that detects light that has passed through the detection surface 43 having light transmitting property. Further, the optical device includes the light transmissive film heater 30 which is arranged adjacent to the optical window 42 having the detection surface and has the heating portion 35 for heating the optical window. Then, the light transmissive film heater 30 has a temperature distribution in which a temperature of an outer region located on an outer side in a radial direction about a center line CL of the detection surface 43 in the heating portion 35 is higher than a temperature of a region located on a center side of the detection surface 43 from the outer region of the heating portion 35.

According to such a configuration, the light transmissive film heater 30 has a temperature distribution in which a temperature of an outer region located on an outer side in a radial direction about a center line CL of the detection surface 43 in the heating portion 35 is higher than a temperature of a region located on a center side of the detection surface 43 from the outer region of the heating portion 35. Therefore, the occurrence of fogging from the peripheral edge of the heating portion 35 can be suppressed, and the occurrence of fogging can be further suppressed.

Further, the light transmissive film heater 30 includes the heat ray heater 38 that heats an outer region on the outer side in the radial direction about the center line of the detection surface 43.

As described above, the light transmissive film heater 30 can include the heat ray heater 38 that heats the outer region on the outer side in the radial direction about the center line CL of the detection surface 43.

Further, the optical device 1 of the present embodiment includes the light transmissive film heater 30 having the heating portion 35 which is arranged adjacent to the optical window 42 having light transmitting property and heats the optical window 42, and the heat ray heater 38 which generates heat in a predetermined region as a heating portion.

Further, the light transmissive film heater 30 has a first electrode 31 arranged on the outer side in the radial direction about the center line of a predetermined region of the optical window 42 in the heating portion 35. Further, the light transmissive film heater 30 has a second electrode 32 so as to interpose a predetermined region of the optical window 42 from both sides together with the first electrode 31 in the heating portion 35. Further, the heating portion 35 has a first heat generating region E1 in which heat generates according to the potential difference between the first electrode 31 and the second electrode 32. Then, the heat ray heater 38 generates heat in an outer region located radially outside the center line of a predetermined region of the optical window 42 with respect to a first heat generation region E1. A center line of the predetermined region of the optical window 42 coincides with the center line CL of the detection surface 43.

According to such a configuration, the heating portion 35 has a first heat generating region E1 in which heat generates according to the potential difference between the first electrode 31 and the second electrode 32. Then, the heat ray heater 38 as the heat generating portion generates heat in the outer region located radially outside the center line CL of the predetermined region of the optical window 42 from the first heat generating region E1, so that the generation of fogging from the peripheral edge of the heating portion 35 is suppressed, and the generation of fogging can be further suppressed.

### Second Embodiment

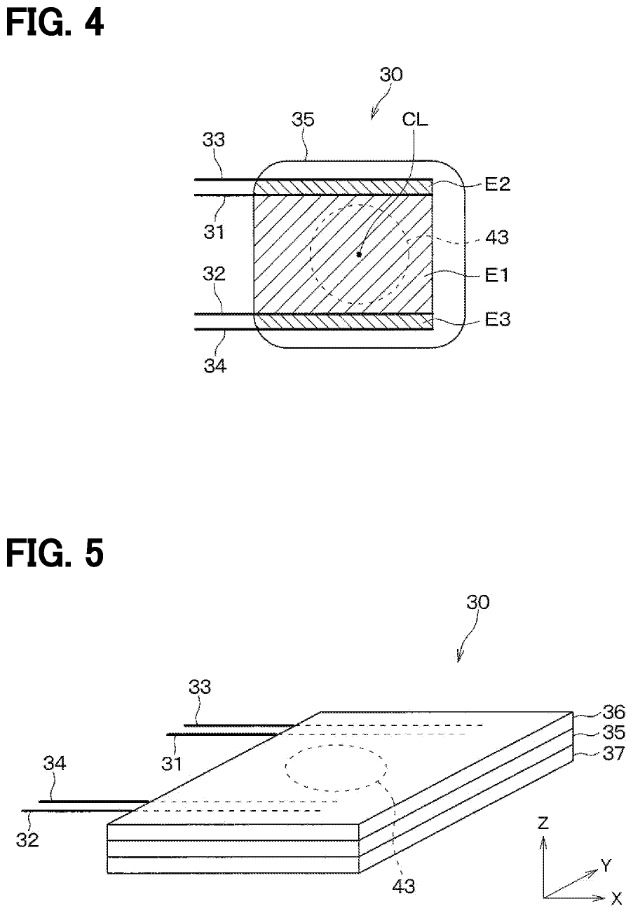

The optical device 1 according to the second embodiment will be described with reference to FIGS. 3 to 4. The optical device 1 of the present embodiment includes a first electrode 31 to a fourth electrode 34 and a heating portion 35.

The first electrode 31 is arranged on the outer side in the radial direction about the center line CL of the detection surface 43 in the heating portion 35. The second electrode 32 is arranged in the heating portion 35 so as to interpose the detection surface 43 from both sides together with the first electrode 31.

Further, the third electrode 33 is arranged in the heating portion 35 on the radial side of the detection surface 43 from the first electrode 31 side. The fourth electrode 34 is arranged in the heating portion 35 on the radial side of the detection surface 43 from the second electrode 32 side. The first electrode 31 to the fourth electrode 34 each have a linear shape. Further, the first electrode 31 to the fourth electrode 34 are parallel to each other.

Further, a distance between the first electrode 31 and the third electrode 33 is the same as a distance between the second electrode 32 and the fourth electrode 34. Further, each of the distance between the first electrode 31 and the third electrode 33 and the distance between the second electrode 32 and the fourth electrode 34 is smaller than the distance between the first electrode 31 and the second electrode 32.

In the present embodiment, a potential of the first electrode 31 is controlled to 0 volt, a potential of the second electrode 32 is controlled to 12 volt, a potential of the third electrode 33 is controlled to 12 volt, and a potential of the fourth electrode 34 is controlled to 0 volt.

As shown in FIG. 4, the heating portion 35 has a first heat generating region E1 in which heat generates according to the potential difference between the first electrode 31 and the second electrode 32. Further, the heating portion 35 has a second heat generating region E2 that generates heat according to the potential difference between the first electrode 31 and the third electrode 33. Further, the heating portion 35 has a third heat generating region E3 that generates heat according to the potential difference between the second electrode 32 and the fourth electrode 34. The heat generation temperature of the second heat generation region E2 and the third heat generation region E3 is higher than the heat generation temperature of the first heat generation region E1.

As described above, the light transmissive film heater 30 has a temperature distribution in which a temperature of the outer region on the radial outer side of the detection surface 43 in the heating portion 35 is higher than a temperature of the region on the center side of the detection surface 43 from the outer region in the heating portion 35. Therefore, the occurrence of fogging from the peripheral edge of the heating portion can be suppressed, and the occurrence of fogging can be further suppressed.

Further, the light transmissive film heater of the present embodiment has a first electrode 31 arranged on the outer side in the radial direction about the center line of the detection surface 43 in the heating portion 35. Further, the second electrode 32 is arranged in the heating portion 35 so as to interpose the detection surface 43 from both sides together with the first electrode 31. Further, the third electrode 33 is arranged in the heating portion 35 on the radial side of the detection surface 43 from the first electrode 31 side. Further, a fourth electrode 34 is arranged radially outside the detection surface 43 from the second electrode 32 side in the heating portion 35.

Further, the heating portion 35 has a first heat generating region E1 in which heat generates according to the potential difference between the first electrode 31 and the second electrode 32. Further, the heating portion 35 has a second heat generating region E2 that generates heat according to the potential difference between the first electrode 31 and the third electrode 33. Further, the heating portion 35 has a third heat generating region E3 that generates heat according to the potential difference between the second electrode 32 and the fourth electrode 34. Then, the heat generating portion generates heat in the second heat generating region E2 and the third heat generating region E3 as the outer region.

According to such a configuration, since the heat generating portion generates heat in the second heat generating region E2 and the third heat generating region E3 as the outer region, the generation of fogging from the peripheral edge of the heating portion 35 is suppressed, and the generation of fogging ca be further suppressed.

In the present embodiment, the same advantages as those obtained from the configuration common to the first embodiment can be obtained in the same manner as in the first embodiment.

### Third Embodiment

The optical device 1 according to the third embodiment will be described with reference to FIG. 5. In the optical device 1 of the second embodiment, the first electrode 31 to the fourth electrode 34 are arranged on the same plane. On the other hand, in the optical device 1 of the present embodiment, the first electrode 31 and the third electrode 33 are arranged at a different position in the heating portion 35 in the thickness direction, and the second electrode 32 and the fourth electrode 34 are further arranged at a different position in the thickness direction in the heating portion 35.

The heating portion 35 is formed in a thin plate shape that extends along an X-Y plane defined by a X-axis and a Y-axis. The heating portion 35 has a thickness in the Z-axis direction orthogonal to the X-Y plane.

A protective layer 36 is arranged on one surface of the heating portion 35, and a protective layer 37 is arranged on the opposite surface of the heating portion 35.

The first electrode 31 and the second electrode 32 are arranged on the surface of the heating portion 35 on the protective layer 37 side, and the third electrode 33 and the fourth electrode 34 are arranged on the surface of the heating portion 35 on the protective layer 36 side.

That is, the first electrode 31 and the second electrode 32 are arranged at the same position in the heating portion 35 in the thickness direction. Further, the first electrode 31 and the third electrode 33 are arranged at different position in the heating portion 35 in the thickness direction, and the second electrode 32 and the fourth electrode 34 are arranged at different position in the heating portion 35 in the thickness direction.

A heat generation region that generates heat according to the potential difference between the first electrode 31 and the third electrode 33 and a heat generation region that generates heat according to the potential difference between the second electrode 32 and the fourth electrode 34 have a higher heat generation temperature than the heat generation region that generates heat according to the potential difference between the first electrode 31 and the second electrode 32.

As described above, the light transmissive film heater 30 has a temperature distribution in which a temperature of the outer region on the radial outer side of the detection surface 43 in the heating portion 35 is higher than a temperature of the region on the center side of the detection surface 43 from the outer region in the heating portion 35. Therefore, the occurrence of fogging from the peripheral edge of the heating portion can be suppressed, and the occurrence of fogging can be further suppressed.

Further, the light transmissive film heater of the present embodiment has the third electrode 33 arranged on the radial side of the detection surface 43 from the first electrode 31 side in the heating portion 35. Further, a fourth electrode 34 is arranged radially outside the detection surface 43 from the second electrode 32 side in the heating portion 35.

Further, the heating portion 35 has a first heat generating region E1 in which heat generates according to the potential difference between the first electrode 31 and the second electrode 32. Further, the heating portion 35 has a second heat generating region E2 that generates heat according to the potential difference between the first electrode 31 and the third electrode 33. Further, the heating portion 35 has a third heat generating region E3 that generates heat according to the potential difference between the second electrode 32 and the fourth electrode 34.

Further, the first electrode 31 and the second electrode 32 are arranged at the same position in the heating portion 35 in the thickness direction. Further, the first electrode 31 and the third electrode 33 are arranged at different position in the heating portion 35 in the thickness direction, and the second electrode 32 and the fourth electrode 34 are arranged at different position in the heating portion 35 in the thickness direction. Then, the heat generating portion generates heat in the second heat generating region E2 and the third heat generating region E3 as the outer region.

According to such a configuration, since the heat generating portion generates heat in the second heat generating region E2 and the third heat generating region E3 as the outer region, the generation of fogging from the peripheral edge of the heating portion 35 is suppressed, and the generation of fogging ca be further suppressed.

In the present embodiment, the same advantages as those obtained from the configuration common to the first embodiment can be obtained in the same manner as in the first embodiment.

Further, in the light transmissive film heater 30 of the present embodiment, the first electrode 31 and the third electrode 33 are arranged at different positions in the heating portion 35 in the thickness direction, and the second electrode 32 and the fourth electrode 34 are arranged at different positions in the heating portion 35 in the thickness direction. That is, each of the first electrodes 31 to the fourth electrode 34 is three-dimensionally arranged. Therefore, the space of the heating portion 35 can be saved.

### Fourth Embodiment

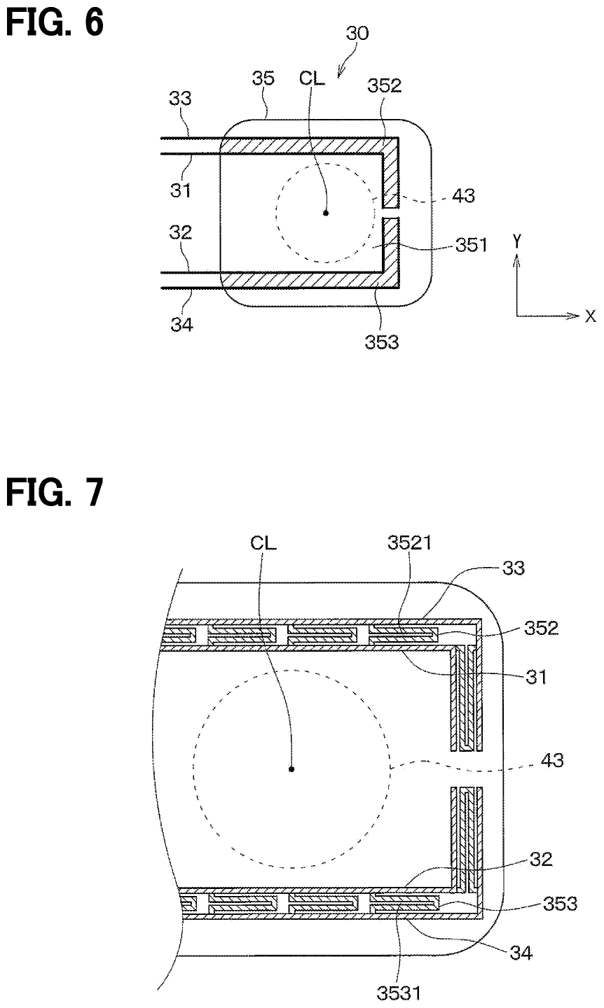

The optical device 1 according to the fourth embodiment will be described with reference to FIG. 6. The optical device 1 of the present embodiment includes a first electrode 31 to a fourth electrode 34, and a light transmissive film heater 30 having a heating portion 35 extending in the X-Y plane direction.

The first electrode 31 is arranged on the outer side in the radial direction about the center line CL of the detection surface 43 in the heating portion 35. The second electrode 32 is arranged in the heating portion 35 so as to interpose the detection surface 43 from both sides together with the first electrode 31.

Further, the third electrode 33 is arranged in the heating portion 35 on the radial side of the detection surface 43 from the first electrode 31 side. The fourth electrode 34 is arranged in the heating portion 35 on the radial side of the detection surface 43 from the second electrode 32 side. The first electrode 31 to the fourth electrode 34 each have an L-shape.

Further, a distance between the first electrode 31 and the third electrode 33 is the same as a distance between the second electrode 32 and the fourth electrode 34. Further, each of the distance between the first electrode 31 and the third electrode 33 and the distance between the second electrode 32 and the fourth electrode 34 is smaller than the distance between the first electrode 31 and the second electrode 32.

In the present embodiment, a potential of the first electrode 31 is controlled to 0 volt, a potential of the second electrode 32 is controlled to 12 volt, a potential of the third electrode 33 is controlled to 12 volt, and a potential of the fourth electrode 34 is controlled to 0 volt.

The heating portion 35 has a first heating part 351 that generates heat according to the potential difference between the first electrode 31 and the second electrode 32. Further, the heating portion 35 has a second heating part 352 that generates heat according to the potential difference between the first electrode 31 and the third electrode 33. Further, the heating portion 35 has a third heating part 353 that generates heat according to the potential difference between the second electrode 32 and the fourth electrode 34. The second heating part 352 and the third heating part 353 each have an L-shape. Further, a U-shaped heating portion is formed by the second heating part 352 and the third heating part 353. The second heating part 352 and the third heating part 353 are arranged so as to surround the first heating part 351. In FIG. 6, the second heating part 352 and the third heating part 353 are shown by hatching.

Further, the first heating part 351 and the second heating part 352 and the third heating part 353 are made of the same material.

According to such a configuration, the light transmissive film heater 30 has a temperature distribution in which a temperature of an outer region located on an outer side in a radial direction about a center line CL of the detection surface 43 in the heating portion 35 is higher than a temperature of a region located on a center side of the detection surface 43 from the outer region of the heating portion 35. Therefore, the occurrence of fogging from the peripheral edge of the heating portion 35 can be suppressed, and the occurrence of fogging can be further suppressed.

Further, each of the distance between the first electrode 31 and the third electrode 33 and the distance between the second electrode 32 and the fourth electrode 34 is smaller than the distance between the first electrode 31 and the second electrode 32. Therefore, the amount of heat generated by the second heating part 352 and the third heating part 353 becomes too large, which may cause a failure or the like.

Therefore, in this optical device 1, a resistance value of the second heating part 352 determined by the first electrode 31 and the third electrode 33 and a resistance value of the third heating part 353 determined by the second electrode 32 and the fourth electrode 34 are smaller than a resistance value of the first heating part 351 determined by the first electrode 31 and the second electrode 32.

Specifically, the length in the thickness direction of the second heating part 352 and the third heating part 353 is shorter than the length in the thickness direction of the first heating part 351. As a result, the resistance values of the second heating part 352 and the third heating part 353 become smaller than the resistance values of the first heating part 351 so that the calorific value of the second heating part 352 and the third heating part 353 is suppressed.

In the present embodiment, the same advantages as those obtained from the configuration common to the first embodiment can be obtained in the same manner as in the first embodiment.

### Fifth Embodiment

The optical device 1 according to the fifth embodiment will be described with reference to FIG. 7. In the fourth embodiment, a resistance value of the second heating part 352 determined by the first electrode 31 and the third electrode 33 and a resistance value of the third heating part 353 determined by the second electrode 32 and the fourth electrode 34 are larger than a resistance value of the first heating part 351 determined by the first electrode 31 and the second electrode 32. Specifically, the length in the thickness direction of the second heating part 352 and the third heating part 353 is longer than the length in the thickness direction of the first heating part 351.

On the other hand, in this optical device 1, a resistance value of the second heating part 352 determined by the first electrode 31 and the third electrode 33 and a resistance value of the third heating part 353 determined by the second electrode 32 and the fourth electrode 34 are larger than a resistance value of the first heating part 351 determined by the first electrode 31 and the second electrode 32. Specifically, the second heating part 352 and the third heating part 353 are formed with notches 3521 and 3531 for lengthening the current path length of the current flowing through the second heating part 352 and the third heating part 353.

In FIG. 7, the first electrode 31 to the fourth electrode 34, the second heating part 352, and the third heating part 353 are shown by hatching. Further, the first heating part 351 and the second heating part 352 and the third heating part 353 are made of the same material.

The optical device 1 of the present embodiment forms a film-shaped first heating part 351 and a second heating part 352 and a third heating part 353 made from the same material. After that, a notch 3521 is formed in the second heating part 352 by laser processing, and a notch 3531 is formed in the third heating part 353. The notch 3521 and the notch 3531 are each formed so as to extend in the X axis direction.

The resistance value of the second heating part 352 determined by the first electrode 31 and the third electrode 33 becomes larger by the notch 3521, and the resistance value of the third heating part 353 determined by the second electrode 32 and the fourth electrode 34 becomes larger by the notch 3531.

Therefore, the resistance value of the second heating part 352 determined by the first electrode 31 and the third electrode 33 and the resistance value of the third heating part 353 determined by the second electrode 32 and the fourth electrode 34 are larger than the resistance value of the first heating part 351 determined by the first electrode 31 and the second electrode 32. Then, the calorific value of the second heating part 352 and the third heating part 353 is suppressed.

In the present embodiment, the notch 3521 and the notch 3531 are formed so as to extend in the X axis direction, but the notch 3521 and the notch 3531 may be formed so as to be refracted in a complicated manner like a corridor structure.

### Sixth Embodiment

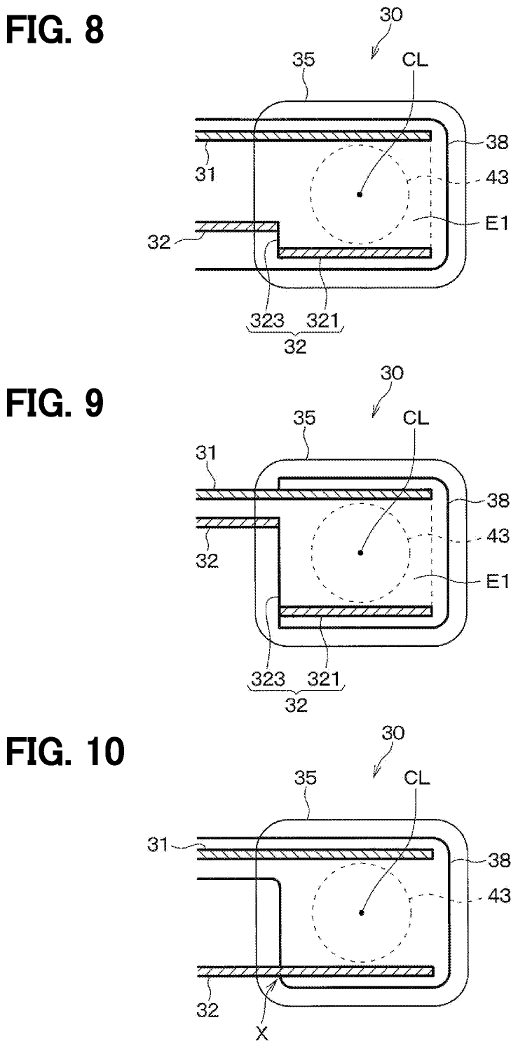

The optical device 1 according to the sixth embodiment will be described with reference to FIG. 8. In the optical device 1 of the present embodiment, a high resistance heat generating part 323 having a high resistance is formed in a part of the second electrode 32. That is, the second electrode 32 has a low resistance part 321 having a low resistance and the high resistance heat generating part 323. The low resistance part 321 and the high resistance heat generating part 323 each have a linear shape and are made of the same material. A line width of the high resistance heat generating part 323 is shorter than a line width of the low resistance part 321 and a cross section of the current path of the high resistance heat generating part 323 is smaller than the cross section of the current path of the low resistance part 321. As a result, the resistance value of the high resistance heat generating part 323 is larger than the resistance value of the low resistance part 321

The high resistance heat generating part 323 is arranged in an outer region located radially outside the center line CL of the detection surface 43 from the first heat generating region E1, and heats the outer region. That is, the high resistance heat generating part 323, which is a part of the second electrode 32, functions as a heater.

The control unit 50 applies a predetermined voltage between the first electrode 31 and the second electrode 32 of the light transmissive film heater 30. When the transparent conductive film forming the control unit 50 is energized via the first electrode 31 and the second electrode 32, the heating portion 35 generates heat. At this time, a current flows through the high resistance heat generating part 323, and the high resistance heat generating part 323 also generates heat. The low resistance part 321 does not generate heat. Further, when the control unit 50 starts energizing the heat ray heater 38, the heat ray heater 38 also generates heat.

As described above, in the optical device of the present embodiment, a part of the second electrode 32 functions as a heater. As a result, it is possible to reduce the size as compared with the case where the heater is configured by using another member.

In the present embodiment, a part of the second electrode 32 is configured to function as a heater, but a part of the first electrode 31 may be configured to function as a heater. Further, at least a part of the first electrode 31 and the second electrode 32 may be configured to function as a heater.

### Seventh Embodiment

The optical device 1 according to the seventh embodiment will be described with reference to FIG. 9. The optical device 1 of the present embodiment is different from the optical device 1 of the sixth embodiment in that the heat ray heater 38 is connected to the first electrode 31 and the second electrode 32. Another difference is that the section of the high resistance heat generating part 323 that functions as a heater in the second electrode 32 is arranged in a part around the optical window 42 having light transmitting property.

The heat ray heater 38 is connected between the first electrode 31 and the second electrode 32. That is, the first electrode 31 is connected to one end of the heat ray heater 38, and the second electrode 32 is connected to the other end of the heat ray heater 38.

According to this configuration, the connection portion for supplying the voltage to the first electrode 31 and the heat ray heater 38 can be shared, and the connection portion for supplying the voltage to the second electrode 32 and the heat ray heater 38 can be shared so that the optical device can be miniaturized.

Further, the heat ray heater 38 as the heat generating portion is arranged so as to surround the periphery of the detection surface 43 except for a part around the optical window 42 having light transmitting property. Further, in the second electrode 32, a portion of the high resistance heat generating part 323 that functions as a heater is arranged in a part around the optical window 42 having light transmitting property.

According to this configuration, in the second electrode 32, the section of the high resistance heat generating part 323 that functions as a heater generates heat in a portion where the heat ray heater 38 does not surround the optical window 42 having light transmitting property so that the generation of fogging from the peripheral edge of the heating portion 35 can be further suppressed.

### Eighth Embodiment

The optical device 1 according to the eighth embodiment will be described with reference to FIG. 10. The optical device 1 of the present embodiment has a larger range in which the heat ray heater 38 surrounds the detection surface 43 with respect to the configuration of the optical device 1 of the first embodiment.

The heat ray heater 38 of the present embodiment is arranged so as to surround almost the entire circumference of the detection surface 43. In FIG. 10, at a portion X where the heat ray heater 38 and the second electrode 32 intersect, an insulating layer (not shown) is arranged between the heat ray heater 38 and the second electrode 32, and the heat ray heater 38 and the second electrode 32 are insulated by the insulating layer.

In this way, the heat ray heater 38 can be configured to surround almost the entire circumference of the detection surface 43.

### Ninth Embodiment

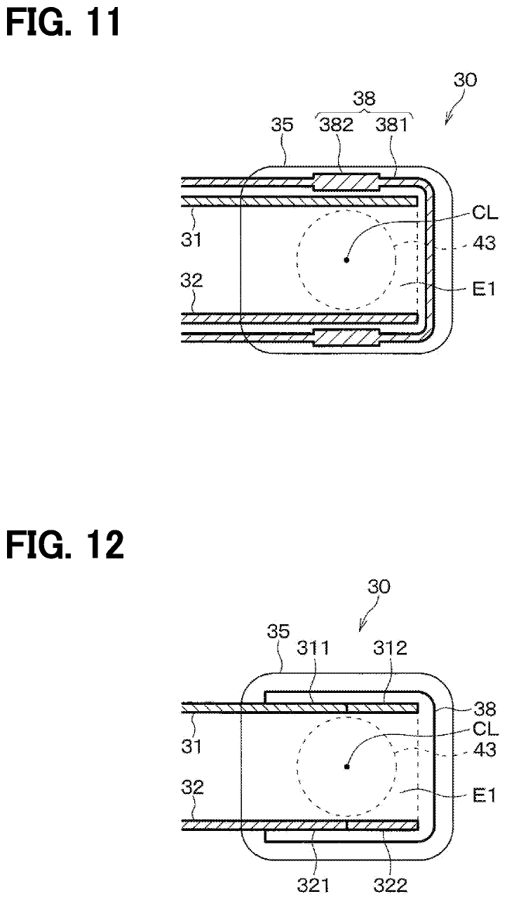

The optical device 1 according to the ninth embodiment will be described with reference to FIG. 11. The optical device 1 of the present embodiment is different from the optical device 1 of the first embodiment in that the line width of the heat ray heater 38 differs depending on locations.

The heat ray heater 38 has a first line width part 381 having a first electrode width and a second line width part 382 having a second electrode width longer than the first electrode width. The first line width part 381 and the second line width part 382 are made of the same material.

Since the second line width part 382 has a larger heat capacity than the first line width part 381, the temperature around the second line width part 382 becomes higher than the temperature around the second line width part 382. That is, the second line width part 382 functions as a heater. Therefore, by forming the second line width part 382 in the low temperature region of the heating portion 35 and arranging the first line width part 381 in the high temperature region of the heating portion 35, it is possible to suppress the temperature unevenness of the heating portion 35.

### Tenth Embodiment

The optical device 1 according to the tenth embodiment will be described with reference to FIG. 12. The optical device 1 of the present embodiment is different in that the heat ray heater 38 is connected to the first electrode 31 and the second electrode 32, and the configuration of the first electrode 31 and the second electrode 32 are different with respect to the optical device of the first embodiment.

The heat ray heater 38 is connected between the first electrode 31 and the second electrode 32. That is, the first electrode 31 is connected to one end of the heat ray heater 38, and the second electrode 32 is connected to the other end of the heat ray heater 38.

According to this configuration, the connection portion for supplying the voltage to the first electrode 31 and the heat ray heater 38 can be shared, and the connection portion for supplying the voltage to the second electrode 32 and the heat ray heater 38 can be shared so that the optical device can be miniaturized.

Further, the first electrode 31 has a low resistance part 311 formed by using a low resistance material and a high resistance part 312 formed by using a high resistance material having a higher resistance than the low resistance material.

Further, the second electrode 32 has a low resistance part 321 formed by using a low resistance material and a high resistance part 322 formed by using a high resistance material having a higher resistance than the low resistance material.

Then, the high resistance part 312 formed by using the high resistance material of the first electrode 31 functions as a heater, and the high resistance part 312 formed by using the high resistance material of the second electrode 32 functions as a heater.

As described above, the first electrode 31 and the second electrode 32 can be configured by using materials having different resistance values, and the portion configured by using the material having a large resistance value can function as a heater.

### Other Embodiments

(1) In each of the above embodiments, the example in which the light transmissive film heater 30 heats the detection surface of the optical window 42 of the camera 40 is shown. On the other hand, for example, the window shield of the vehicle may be regarded as an optical window 42, and a predetermined region of the optical window 42 may be heated by the heating portion 35 of the light transmissive film heater 30.

(2) In the present embodiment, the optical device 1 provided with the camera 40 that captures an image of the surroundings of the vehicle has been described. The optical device 1 can also be configured as, for example, an optical device 1 provided with a distance sensor called LIDAR (Laser Imaging Detection and Ranking), or an optical device 1 provided with a security camera or the like.

(3) In each of the above embodiments, the heating portion 35 is arranged adjacent to the surface opposite to the surface facing the sensor unit 41 of the optical window 42, however, the heating portion 35 may be arranged adjacent to the surface facing the sensor unit 41 of the optical window 42.

(4) In each of the above embodiments, the distance between the first electrode 31 and the third electrode 33 is the same as the distance between the second electrode 32 and the fourth electrode 34. However, the distance between the first electrode 31 and the third electrode 33 may be different from the distance between the second electrode 32 and the fourth electrode 34.

(5) In the first embodiment, the first electrode 31 and the second electrode 32 have the linear shape, and in the second and third embodiments, the first electrode 31 to the fourth electrode 34 have the linear shape. On the other hand, the first electrode 31 and the second electrode 32 in the first embodiment and the first electrode 31 to the fourth electrode 34 in the second and third embodiments may have a shape other than the linear shape.

(6) In the fourth and fifth embodiments, the first heating part 351, the second heating part 352 and the third heating part 353 are made of the same material, but the second heating part 352 and the third heating part 353 may be made of a material different from that of the first heating part 351.

(7) In the first embodiment, when the control unit 50 determines that the detection surface 43 has become cloudy based on the image input from the camera 40, a predetermined voltage is applied between the first electrode 31 and the second electrode 32 of the light transmissive film heater 30, and energization of the heat ray heater 38 is started.

On the other hand, the control unit 50 detects the environmental conditions (temperature, humidity, radiation amount) on both sides or one side of the detection surface 43 and the temperature of the object to be heated, and the control unit 50 may calculate the conditions under which the detection surface 43 becomes cloudy based on the detected environmental conditions and temperature. Then, when the condition that the detection surface 43 becomes cloudy is satisfied, a predetermined voltage may be applied between the first electrode 31 and the second electrode 32 of the light transmissive film heater 30, and energization of the heat ray heater 38 may be started.

The present disclosure is not limited to the above-described embodiments, and can be appropriately modified. The embodiments described above are not independent of each other, and can be appropriately combined except when the combination is obviously impossible. The constituent elelement(s) of each of the above embodiments is/are not necessarily essential unless it is specifically stated that the constituent element(s) is/are essential in the above embodiment, or unless the constituent element(s) is/are obviously essential in principle. Furthermore, in each of the above embodiments, in the case where the number of the constituent element(s), the value, the amount, the range, and/or the like is specified, the present disclosure is not necessarily limited to the number of the constituent element(s), the value, the amount, and/or the like specified in the embodiment unless the number of the constituent element(s), the value, the amount, and/or the like is indicated as indispensable or is obviously indispensable in view of the principle of the present disclosure. Furthermore, a material, a shape, a positional relationship, or the like, if specified in the above-described example embodiments, is not necessarily limited to the specific material, shape, positional relationship, or the like unless it is specifically stated that the material, shape, positional relationship, or the like is necessarily the specific material, shape, positional relationship, or the like, or unless the material, shape, positional relationship, or the like is obviously necessary to be the specific material, shape, positional relationship, or the like in principle.

### Overview

According to the first aspect shown in part or all of the above embodiments, the optical device of the present embodiment includes a sensor unit that senses light that has passed through a detection surface having light transmitting property. Further, the optical device includes the light transmissive film heater which is arranged adjacent to the optical window having the detection surface and has the heating portion for heating the optical window. Then, the light transmissive film heater has a temperature distribution in which a temperature of an outer region located on an outer side in a radial direction about a center line of the detection surface in the heating portion is higher than a temperature of a region located on a center side of the detection surface from the outer region of the heating portion.

Further, according to the second aspect, the light transmissive film heater has a first electrode arranged on the outer side in the radial direction about the center line of the detection surface in the heating portion. Further, the light transmissive film heater includes the second electrode arranged so as to sandwich the detection surface from both sides together with the first electrode in the heating portion, and a third electrode arranged on the radial side of the detection surface from the first electrode side in the heating portion. Further, the fourth electrode 34 is arranged radially outside the detection surface 43 from the second electrode 32 side in the heating portion.

The heating portion includes a first heat generation region that generates heat according to the potential difference between the first electrode and the second electrode, a second heat generation region that generates heat according to the potential difference between the first electrode and the third electrode, and a third heat generation region that generates heat according to the potential difference between the second electrode and the fourth electrode. The heat generation temperature of the second heat generation region and the third heat generation region is higher than the heat generation temperature of the first heat generation region.

Therefore, the occurrence of fogging from the peripheral edge of the heating portion can be suppressed, and the occurrence of fogging can be further suppressed.

Further, according to the third aspect, the first electrode and the second electrode are arranged at the same position in the heating portion in the thickness direction. Further, the first electrode and the third electrode are arranged at different position in the heating portion in the thickness direction, and the second electrode and the fourth electrode are arranged at different position in the heating portion in the thickness direction.

A heat generation region that generates heat according to the potential difference between the first electrode and the third electrode and a heat generation region that generates heat according to the potential difference between the second electrode and the fourth electrode have a higher heat generation temperature than the heat generation region that generates heat according to the potential difference between the first electrode and the second electrode.

That is, each of the first electrodes to the fourth electrode is three-dimensionally arranged. Therefore, the space of the heating portion can be saved.

Further, according to the fourth aspect, the light transmissive film heater includes the heat ray heater that heats an outer region on the outer side in the radial direction about the center line of the detection surface.

As described above, the light transmissive film heater can include the heat ray heater that heats the outer region on the outer side in the radial direction about the center line of the detection surface.

Further, according to the fifth aspect, the light transmissive film heater has a first electrode arranged on the outer side in the radial direction about the center line of the detection surface in the heating portion.

Further, the light transmissive film heater includes the second electrode arranged so as to sandwich the detection surface from both sides together with the first electrode in the heating portion, and a third electrode arranged on the radial side of the detection surface from the first electrode side in the heating portion. Further, the fourth electrode 34 is arranged radially outside the detection surface 43 from the second electrode 32 side in the heating portion.

Further, the heating portion includes a first heating part that generates heat according to the potential difference between the first electrode and the second electrode, and a second heating part that generates heat according to the potential difference between the first electrode and the third electrode.

Further, the heating portion has a third heating part that generates heat according to the potential difference between the second electrode and the fourth electrode. Therefore, the resistance value of the second heating part determined by the first electrode and the third electrode and the resistance value of the third heating part determined by the second electrode and the fourth electrode are larger than the resistance value of the first heating part determined by the first electrode and the second electrode.

As a result, the resistance values of the second heating part and the third heating part become smaller than the resistance values of the first heating part so that the calorific value of the second heating part and the third heating part is suppressed.

Further, according to the sixth aspect, the second heating part and the third heating part are made of the same material as the first heating part, and the lengths in the thickness direction of the second heating part and the third heating part is shorter than the length in the thickness direction of the first heating part.

As a result, the resistance values of the second heating part and the third heating part become smaller than the resistance values of the first heating part so that the calorific value of the second heating part and the third heating part is suppressed.

Further, according to the seventh aspect, the second heating part and the third heating part are made of the same material as the first heating part. Further, at least one of the second heating part and the third heating part is formed with a notch for lengthening the current path length of the current flowing through at least one of the second heating part and the third heating part.

Therefore, the resistance value of the second heating part determined by the first electrode and the third electrode and the resistance value of the third heating part determined by the second electrode and the fourth electrode are larger than the resistance value of the first heating part determined by the first electrode and the second electrode so that the calorific value of the second heating part and the third heating part can be suppressed.

Further, according to the eighth aspect, the second heating part and the third heating part are made of a material different from that of the first heating part. In this way, the second heating part and the third heating part can be made of a material different from that of the first heating part.

Further, according to the ninth aspect, the optical device includes a light transmissive film heater having a heating portion which is arranged adjacent to an optical window having light transmitting property and heats the optical window, and a heat generating portion which generates heat in a predetermined region. In addition, it is provided with a heat generating portion that generates heat in a predetermined area. Further, the light transmissive film heater has a first electrode arranged on the outer side in the radial direction about the center line of a predetermined region of the optical window in the heating portion. Further, the light transmissive film heater has a second electrode so as to interpose a predetermined region of the optical window from both sides together with the first electrode in the heating portion. Further, the heating portion has a first heat generating region in which heat generates according to the potential difference between the first electrode and the second electrode. Then, the heat generating portion generates heat in an outer region located radially outside the center line of a predetermined region of the optical window.

Further, according to the tenth aspect, the light transmissive film heater includes a heat ray heater that heats an outer region radially outside the center of a predetermined region of the optical window, and the heat generating portion is composed of a heat ray heater. In this way, the heat generating portion can be composed of the heat ray heater.

Further, according to the eleventh aspect, the light transmissive film heater has a third electrode arranged radially outside the center line of a predetermined region of the optical window from the first electrode side in the heating portion. Further, the light transmissive film heater has a fourth electrode arranged radially outside the center line of a predetermined region of the optical window from the second electrode side in the heating portion. Further, the heating portion has a first heat generation region and a second heat generation region that generates heat according to the potential difference between the first electrode and the third electrode. Further, the heating portion has a third heat generating region that generates heat according to the potential difference between the second electrode and the fourth electrode. Then, the heat generating portion generates heat in the second heat generating region and the third heat generating region as the outer region. In this way, heat can be generated with the second heat generation region and the third heat generation region as the outer regions.

Further, according to the twelfth aspect, the light transmissive film heater has a third electrode arranged radially outside the center line of a predetermined region of the optical window from the first electrode side in the heating portion. Further, the light transmissive film heater has a fourth electrode arranged radially outside the center line of a predetermined region of the optical window from the second electrode side in the heating portion. Further, the heating portion has a first heat generation region and a second heat generation region that generates heat according to the potential difference between the first electrode and the third electrode. Further, the heating portion has a third heat generating region that generates heat according to the potential difference between the second electrode and the fourth electrode. The first electrode and the second electrode are arranged at the same position in the heating portion in the thickness direction, and the first electrode and the third electrode are arranged at different positions in the heating portion in the thickness direction, and the second electrode and the fourth electrode are arranged at different positions in the heating portion in the thickness direction.

That is, each of the first electrodes to the fourth electrode is three-dimensionally arranged. Therefore, the space of the heating portion can be saved.

Further, according to the thirteenth aspect, the first electrode is connected to one end of the heat ray heater, and the second electrode is connected to the other end of the heat ray heater.

According to this configuration, the connection portion for supplying the voltage to the first electrode and the heat ray heater can be shared, and the connection portion for supplying the voltage to the second electrode and the heat ray heater can be shared so that the optical device can be miniaturized.

Further, according to the fourteenth aspect, at least a part of the first electrode and the second electrode functions as a heater. As a result, it is possible to reduce the size as compared with the case where the heater is configured by using another member.

Further, according to the fifteenth aspect, at least one of the first electrode and the second electrode has a linear shape, and the first electrode and the second electrode have the first electrode width and the second electrode width shorter than the first electrode width. Then, in at least one of the first electrode and the second electrode, the portion becoming the second electrode width functions as a heater.

As described above, since the electrode width of the electrode is shortened and the portion where the electrode width is shortened functions as a heater, the heater can be configured with a simple configuration, and low cost can be realized.

Further, according to the sixteenth aspect, at least one of the first electrode and the second electrode is formed by using a portion formed by using a low resistance material and a high resistance material having a higher resistance than the low resistance material. Then, in at least one of the first electrode and the second electrode, a portion formed of the high resistance material functions as a heater.

In this way, since the material constituting the electrode has a high resistance to function as a heater, the heater can be configured with a simple configuration, and low cost can be realized.

Further, according to the seventeenth aspect, the heat generating portion is arranged so as to surround the periphery of the detection surface except for a part around the predetermined region of the optical window, and a portion of at least one of the first electrode and the second electrode that functions as a heater is arranged in a part around a predetermined region of the optical window.

According to this configuration, at least one of the first electrode and the second electrode has a heat generating portion arranged in a portion where the heat ray heater does not surround the detection surface, so that the fogging generated from the peripheral edge of the heating portion can be more suppressed.

What is claimed is:

1. A heater device, comprising:
a light transmissive film heater configured to apply to an optical window that is arranged adjacent to a sensor unit for detecting light and includes a detection surface having a light transmitting property, and including a heating portion heating the optical window; and
a heat generating portion configured to generate heat in a predetermined region, wherein
the light transmissive film heater includes
a first electrode arranged radially outside about a center line of the detection surface in the heating portion,
a second electrode arranged in the heating portion so as to interpose the detection surface from both sides together with the first electrode,
a first heat generation region that generates heat according to a potential difference between the first electrode and the second electrode generated by energization from the first electrode to the second electrode via the heating portion, and
the heat generating portion generates heat in the predetermined region so as to have a temperature distribution in which a temperature of an outer region located radially outside about a center line of the detection surface with respect to the heat generation region is higher than the temperature of the first heat generation region.

2. The heater device according to claim 1, wherein
the heat generating portion is composed of a heat ray heater.

3. The heater device according to claim 1, wherein
the light transmissive film heater has
a third electrode arranged radially outside around the center line of a predetermined region of the optical window from the first electrode side in the heating portion, and
a fourth electrode arranged radially outside around the center line of a predetermined region of the optical window from the second electrode side in the heating portion,
the heating portion includes
a first heat generation region,
a second heat generation region that generates heat according to a potential difference between the first electrode and the third electrode, and
a third heat generation region that generates heat according to a potential difference between the second electrode and the fourth electrode, and
the heat generating portion generates heat in the second heat generating region and the third heat generating region as the outer region.

4. The heater device according to claim 1, wherein
the light transmissive film heater has
a third electrode arranged radially outside around the center line of the detection surface from the first electrode side in the heating portion, and
a fourth electrode arranged radially outside around the center line of the detection surface from the second electrode side in the heating portion,
the heating portion includes
a first heat generation region,
a second heat generation region that generates heat according to a potential difference between the first electrode and the third electrode, and
a third heat generation region that generates heat according to a potential difference between the second electrode and the fourth electrode, and
the first electrode and the second electrode are arranged at the same position in the thickness direction in the heating portion,
the first electrode and the third electrode are arranged at different positions in the thickness direction in the heating portion, and
the second electrode and the fourth electrode are arranged at different positions in the heating portion in the thickness direction.

5. The heater device according to claim 2, wherein
the heat ray heater has a linear shape,
the first electrode is connected to one end of the heat ray heater, and
the second electrode is connected to the other end of the heat ray heater.

6. The heater device according to claim 1, wherein
at least a part of the first electrode and the second electrode functions as a heater.

7. The heater device according to claim 6, wherein
at least one of the first electrode and the second electrode has a linear shape, and has a first electrode width and a second electrode width shorter than the first electrode width, and
in at least one of the first electrode and the second electrode, the portion becoming the second electrode width functions as a heater.

8. The heater device according to claim 6, wherein
at least one of the first electrode and the second electrode has a portion formed by using a low resistance material and a portion formed by using a high resistance material having a higher resistance than the low resistance material, and
in at least one of the first electrode and the second electrode, a portion formed of the high resistance material functions as a heater.

9. The heater device according to claim 6, wherein
the heat generating portion is arranged so as to surround the periphery of the predetermined region of the optical window except for a part around the predetermined region of the optical window, and
in at least one of the first electrode and the second electrode, a portion that functions as the heater is arranged in a part around a predetermined region of the optical window.

10. The heater device according to claim 1, wherein
the light transmissive film heater has
a first electrode arranged radially outside the center line of the detection surface in the heating portion,
a second electrode arranged so as to interposed the detection surface from both sides together with the first electrode in the heating portion,
a third electrode arranged radially outside the detection surface from the first electrode side in the heating portion, and
a fourth electrode arranged radially outside the detection surface from the second electrode side in the heating portion,
the heating portion includes
a first heating part that generates heat according to a potential difference between the first electrode and the second electrode,
a second heating part that generates heat according to a potential difference between the first electrode and the third electrode, and
a third heating part that generates heat according to a potential difference between the second electrode and the fourth electrode, and
a resistance value of the second heating part determined by the first electrode and the third electrode and a resistance value of the third heating part determined by the second electrode and the fourth electrode are larger than a resistance value of the first heating part determined by the first electrode and the second electrode.

11. The heater device according to claim 10, wherein
the second heating part and the third heating part are made of the same material as the first heating part, and
a length in the thickness direction of the second heating part and the third heating part is shorter than a length in the thickness direction of the first heating part.

12. The heater device according to claim 10, wherein
the second heating part and the third heating part are made of the same material as the first heating part, and
at least one of the second heating part and the third heating part is formed with a notch for lengthening a current path length of the current flowing through at least one of the second heating part and the third heating part.

13. The heater device according to claim 10, wherein
the second heating part and the third heating part are made of a material different from that of the first heating part.
